(19) United States
(12) Patent Application Publication
(10) Pub. No.: US 2004/0004828 A1
(43) Pub. Date: Jan. 8, 2004

(54) SPINNING ILLUMINATED NOVELTY DEVICE WITH SYNCRONIZED LIGHT SOURCES

(76) Inventors: Mark Chernick, Woodinville, WA (US); Webb Nelson, Woodinville, WA (US)

Correspondence Address: LaMorte & Associates, P.C., P.O. Box 434, Yardley, PA, 19067-8434, US

(21) Appl. No.: 10/188,821

(22) Filed: Jul. 5, 2002

(51) Int. Cl. F21V 21/30

(52) U.S. Cl. 362/35; 362/184; 362/231; 362/800

(57) ABSTRACT

A novelty item that spins at least one array of lights to produce a predetermined changing pattern of lights. The device has at least one array of lights that is supported by at least one flexible arm. The arms radially extend from a spinning hub. Consequently, when the arms rotate, the various lights in the array of lights rotate about the hub in a variety of circular pathways. A control circuit is provided in the hub that spins with the arms. The lights in the array of lights are coupled to the control circuit. The control circuit selectively flashes the lights in the array of lights in a manner that is synchronous to the speed at which the various lights are traveling in their circular pathways. As a result, the control circuit can cause the spinning array of lights to produce any desired pattern, display or alphanumeric message.

### BACKGROUND OF THE INVENTION

1. Field of the Invention

The present invention relates to illuminated novelty devices that are used to produce observable patterns of light during low light conditions. More particularly, the present invention relates to such novelty devices where the observed pattern of light is produced from an array of spinning light sources.

2. Prior Art Statement

In the prior art, there are many different types of illuminated novelty devices that produce an observable pattern of light. Such devices are not used for the purposes of illumination, like a flashlight. Rather, such novelty devices are merely used to produce an interesting pattern of light that can be observed during low light conditions. Such novelty devices are commonly sold or distributed at events that are frequented by children and where there are low light conditions. Examples of such events include children's concerts, the circus, amusement parks at night, fireworks displays and the like.

There is a great variety in the types of illuminated novelty devices that exist. Some illuminated novelty devices use chemical luminescent light sources, where the observed light is created from a chemical reaction. Such chemical luminescent devices, however, cannot be selectively turned on and off once the chemical reaction has started. Furthermore, after a few hours, the chemical reaction ends and the novelty device is incapable of producing light. Furthermore, most chemical compositions used to produce light are toxic. Accordingly, the use of chemical luminescent novelty devices is inappropriate for many young children who may bite or teethe on the device.

Other types of illuminated novelty devices use batteries to provide power to either incandescent bulbs or light emitting diodes (LEDs). Often, to increase the interest of the pattern of light produced by the device, motors are used to move the electric light sources when they are illuminated. One popular type of illuminated novelty device is a device where multiple electric light sources are positioned on the tips of narrow flexible arms. The flexible arms are attached to a hub that is supported by a handle. In the handle is a motor that spins the hub when activated. As such, when a user activates the motor, the hub spins and the lights at the ends of the arms illuminate. The result is a circular pattern of light that is interesting to observe especially in low light conditions.

A problem associated with spinning electric novelty devices is one of play value. Once a child observes the pattern of light emitted by some prior art spinning lights, the child quickly becomes bored with the pattern of light produced. As such, the child no longer is interested in playing with the toy. This is particularly annoying to the parent of the child who just paid a substantial sum of money to buy the spinning light toy.

A need therefore exists for a spinning novelty light that produces a changing pattern of lights that is highly interesting to an observer, especially a child observer, thereby increasing the play value of the device. This need is met by the present invention as described and claimed below.

### SUMMARY OF THE INVENTION

The present invention is a novelty item that spins at least one array of lights to produce a predetermined changing pattern of lights. The device has at least one array of lights that is supported by at least one flexible arm. The arms radially extend from a spinning hub. Consequently, when the arms rotate, the various lights in the array of lights rotate about the hub in a variety of circular pathways. A control circuit is provided in the hub that spins with the arms. The lights in the array of lights are coupled to the control circuit. The control circuit selectively flashes the lights in the array of lights in a manner that is synchronous to the speed at which the various lights are traveling in their circular pathways. As a result, the control circuit can cause the spinning array of lights to produce any desired pattern, display or alphanumeric message.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is a perspective view of one exemplary embodiment of the present invention;

FIG. 2 is a selectively cross-sectioned view of the embodiment shown in FIG. 1; and

FIG. 3 is a top view of spinning arms that create a circular pattern of light.

### DETAILED DESCRIPTION OF THE DRAWINGS

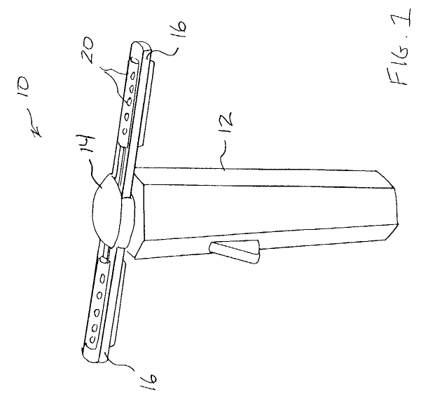

Referring to FIG. 1, a first exemplary embodiment of the present invention device 10 is show. The device 10 contains a handle 12. The handle 12 supports a hub 14. Arms 16 radially extend from the hub 14. In the shown embodiment, two arms 16 extend from the hub 14. However, it should be understood that such a number is arbitrary and any number of arms 16 can be made to radially extend from the hub 14.

In the shown embodiment, each of the arms 16 supports a plurality of light sources 20 in a fixed position. The light sources 20 can be incandescent bulbs, but are preferably high-output light emitting diodes (LEDs). The light emitted by the light sources 20 can be any color or combination of colors, depending upon the type of bulbs or LEDs selected. Although five linearly aligned light sources 20 are specifically illustrated on each arm 16, it should be understood that any array of light sources can be mounted on any arm 16 in any desired configuration.

The hub 14 rotates relative the handle 12. Accordingly, as the hub 14 rotates, the arms 16 extending from the hub 14 also rotate. As the hub 14 and arms 16 rotate, current is directed to the light sources 20. Consequently, the light sources 20 illuminate as they spin, thereby producing circular patterns of light. The speed at which the light sources 20 are rotated is known. The light sources 20 are connected to a control circuit that selectively turns on and off the light sources 20 in at least one preprogrammed sequence. The control circuit is synchronized to the speed of rotation for the hub 14. Consequently, as the light sources 20 spin, complex changing patterns of light can be produced. If desired, even alpha-numeric messages can be generated.

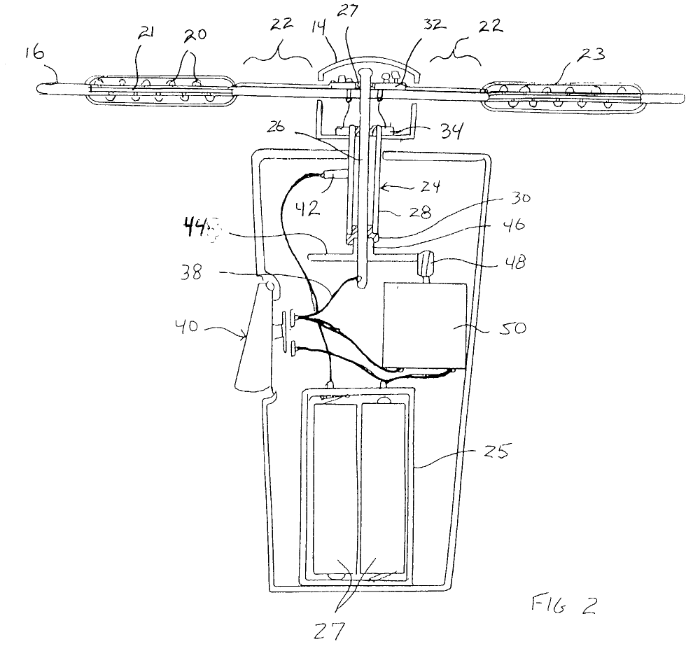

Referring to FIG. 2, it can be seen that on each of the arms 16, the light sources 20 are mounted to circuit boards 21. The circuit boards 21 are not flexible. Rather, each circuit board 21 is a rigid structure that is supported by the structure of the arm 16. However, each arm 16 is made of flexible material. The flexible material is preferably an elastomeric material, such as a type of synthetic rubber, silicone or foam rubber. As such, the arms 16 are free to bend and twist even though the circuit boards 21 that the arms 16 support, are not. The circuit boards 21 are much shorter than are the arms 16. Consequently, the arms 16 are unencumbered by the circuit boards 21 in the section 22 of the arms 16 immediately adjacent the hub 14. The arms 16 are therefore free to bend up and down and twist side to side in the unencumbered sections 22.

Since the material of the arms 16 is elastomeric, it provides a natural safety structure. The elastomeric material of the arms 16 surrounds the periphery of the circuit boards 21. Accordingly, if some object, such as a child's face, were to contact the arms 16 as they rotate, the soft elastomeric material of the arms 16 would be the part of the arms 16 that makes contact. Since the material of the arms 16 is soft and flexible, it is not likely to cause injury.

The light sources 20 and the circuit boards 21 are only protected around their periphery by the elastomeric material of the arms 16. To prevent the light sources 20 and the circuit boards 21 from being contacted either from above or below, transparent covers 23 protect the light sources 20 and circuit boards 21. The transparent covers 23 extend over the light sources 20 and the circuit boards 21 yet enable the light sources 20 to be readily viewed.

From FIG. 2, it can be seen that in the handle 12, there is a port 25 for holding batteries 27. The power from the batteries 27 is used to both illuminate the light sources 20 and rotate the arms 16.

The hub 14 is connected to a shaft assembly 24 that extends upwardly from the handle 12. The shaft assembly 24 contains a conductive inner shaft 26 and a conductive outer shaft 28. The inner shaft 26 and the outer shaft 28 are insulated from each other using spacers 30 that are disposed in between the inner shaft 26 and the outer shaft 28. The spacers 30 also act as bearings between the inner shaft 26 and the outer shaft 28. As such, the outer shaft 28 is free to rotate independently of the inner shaft 26.

In the hub 14, there is located a central circuit board 32 that spins around the inner shaft 26. A wiper contact 27 is mounted on the central circuit board 32 that makes electrical contact with the inner shaft 26. A control circuit is mounted to the central circuit board 32 in the hub 14. The control circuit receives one of the leads from each of the light sources 20. The control circuit contains the circuitry that lights the various light sources in at least one predetermined sequence to produce a desired changing pattern of light.

In the hub 14 is also located a second connector 34. The second connector 34 is coupled to both the structure of the hub 14 and the outer shaft 28. The second lead from each light source 20 is coupled to the outer shaft 28, via the second connector 34.

The inner shaft 26 is coupled to one terminal of a battery port 25 utilizing a wire pathway 38. The wire pathway 38 is disrupted by an on/off switch 40 that can be manually activated by a person holding the handle 12. Accordingly, a person holding the handle 12 can selectively control the on/off switch 40 and therefore can control the flow of electrical power to the inner shaft 26.

The opposite terminal of the battery port 25 is coupled to a wiping contact 42. The wiping contact 42 presses against the outer shaft 28 of the shaft assembly 24. Accordingly, when the on/off switch 40 is manually closed, a circuit is completed. The circuit starts at one terminal of the battery port 25 and then travels through the inner shaft 26 up to the light sources 20. The circuit then returns to the opposite terminal of the battery port 25 from the light sources 20 through the outer shaft 28, via the wiping contact 42. It should therefore be understood that each time the on/off switch 40 is pressed closed, the light sources 20 illuminate.

A drive gear 44 is disposed around the inner shaft 26. However, the drive gear 44 is not attached to the inner shaft 26 and therefore spins freely about the inner shaft 26. The drive gear 44 has a protrusion 46 that engages the spacer 30 between the inner shaft 26 and the outer shaft 28. Accordingly, when the drive gear 44 spins, the drive gear 44 turns the spacer 30, thereby turning the outer shaft 28. The outer shaft 28 is connected to the hub 14. Consequently, when the outer shaft 28 spins, the hub 14 spins. However, the connection between the hub 14 and the spacer 30 is only a friction connection. Accordingly, should the hub 14 be prevented from spinning due to contact with a foreign object, the drive gear 44 will still spin independently of the spacer 30. This friction interconnection acts as a clutch and prevents the drive gear 44 from becoming damaged should the spinning hub 14 ever suddenly strike an object and stop spinning.

The drive gear 44 is turned by a pinion gear 48. The pinion gear 48 is directly turned by an electric motor 50. The electric motor 50 rotates at a known speed. Accordingly, when the electric motor 50 is activated, the electric motor 50 turns the pinion gear 48, that turns the drive gear 44, that turns the outer shaft 28, that turns the hub 14, that turns the arms 16. Since the speed at which the electric motor 50 spins is known, the rotational speed of the arms 16 is also known because it is proportional to the speed of the electric motor 50 multiplied by the diameter ratio between the drive gear 44 and the pinion gear 48.

The wire pathway that connects the electric motor 50 to the battery port 25 also passes through the on/off switch 40. Consequently, when the on/off switch 40 is pressed, power is supplied to the light sources 20 and power is supplied to the motor 50 that turns the hub 14.

In the shown embodiment of FIG. 1 and FIG. 2, the array of light sources 20 is a single straight line of LEDs. It will be understood that the array of light sources can be a matrix of LEDs where multiple LEDs are arranged in rows and columns. The use of a single row of LEDs is merely exemplary.

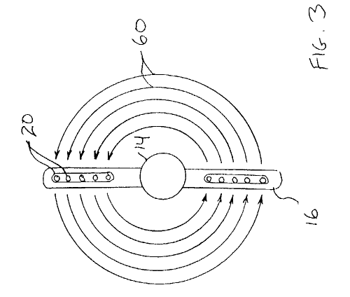

Referring now to FIG. 3, it can be seen that as the light sources 20 rotate, each light source 20 follows its own circular path 60 around the hub 14. The circular path 60 of any one light source 20 depends upon the distance between that light source 20 and the center of the hub 14. The light sources 20 on the separate arms 16 can all have unique pathways. However, in the shown embodiment of FIG. 3, each of the light sources 20 on one arm 16 shares the same pathway as a light source 20 on the opposite arm 16. Accordingly, although there are ten light sources 20 shown on two arms 16, they create only five circular paths 60 of light as they spin.

As the light sources 20 on the arms 16 spin, the control circuit on the central circuit board 32 (FIG. 2) selectively turns on and off the light sources 20 in a preprogrammed pattern. The pattern programmed into the control circuit produces at least one changing pattern of lights. The changing pattern of lights can create a geometric pattern, a recognizable shape, such as Mickey Mouse ears, or alphanumeric characters as the light sources 20 spin.

In order for the array of light sources 20 on the moving arms 16 to produce a readable display, the lighting of the various light sources 20 on the arms 16 must be synchronized with the rate of rotation of the arms 16. If the lighting of the light sources 20 is not synchronized with the movement of the light sources 20, then the pattern or message set forth by the light sources 20 will appear as a blur and will not be readable.

The speed at which the arms 16 spin is a known constant in the present invention. The circular path 60 of each of the light sources 20 is also known. Knowing the speed of rotation and the circular path 60 of each light source 20, the relative speed of each light source 20 is readily calculated. The control circuit on the central circuit board 32 (FIG. 2) is preprogrammed with the relative speed of each of the light sources 20 on the arms 16. The control circuit can then synchronize the lighting of the various light sources 20 to create a clear display of any preprogrammed pattern and/or message.

It will be understood that the embodiment of the present invention specifically described and illustrated is merely exemplary and the shown embodiment can be modified in many ways. For example, the number of light sources, the number of arms and the position of the light sources on the arms can be varied in any manner by a person skilled in the art. Furthermore, the shape of the arms, the hub and the handle can be varied. In the shown embodiment, the arms have an elongated rectangular shape. This shape can be varied into any shape including recognizable object shapes such as Mickey Mouse arms, dinosaur legs and the like. All such alternate embodiments and variations are intended to be included within the scope of the claims as listed below.

What is claimed is:

1. An illuminated assembly, comprising:
a hub;
a motor for rotating said hub;
a plurality of flexible arms extending from said hub;
a plurality of light sources supported by at least one of said plurality of arms, wherein at least some of said plurality of light sources are positioned at different distances-from said hub;
a control circuit disposed within said hub that selectively lights said light sources as said arms spin to produce a predetermined changing pattern of light.

2. The assembly according to claim 1, wherein said control circuit rotates with said hub.

3. The assembly according to claim 1, wherein said light sources are mounted on circuit boards and said circuit boards are mounted on said arms, wherein said arms are flexible and surround the periphery of said circuit boards.

4. The assembly according to claim 3, further including transparent covers that cover said light sources on said circuit boards on at least one side of said arms.

5. The assembly according to claim 3, further including a section on each of said arms, between said hub and said circuit board where said arms are free to resiliently bend.

6. The assembly according to claim 1, further including a handle element for supporting said hub, wherein said motor is disposed within said handle.

7. The assembly according to claim 1, wherein said light sources on separate arms rotate in the same circular pathway as said arms spin.

8. The assembly according to claim 1, wherein said light sources are light emitting diodes.

9. The assembly according to claim 1, wherein different light sources within said plurality of light sources emit different colored light.

10. An illuminated assembly, comprising:
a plurality of arms disposed around a central point, wherein each of said arms is fabricated from an elastomeric material;
an array of light sources supported by said arms; and
a control circuit disposed around said central point that rotates with said arms and selectively controls the lighting of said array of light sources to produce a predetermined pattern of lights as said arms rotate.

11. The assembly according to claim 10, wherein said array of light sources is mounted on circuit boards and said circuit boards are mounted on said arms, wherein said arms surround the periphery of said circuit boards.

12. The assembly according to claim 11, further including transparent covers that cover said array of light sources on said circuit boards on at least one side of said arms.

13. The assembly according to claim 11, further including a section on each of said arms, between said central point and said circuit board where said arms are free to resiliently bend.

14. The assembly according to claim 10, further including a handle element for supporting said arms, and a motor disposed within said handle for rotating said arms.

15. The assembly according to claim 10, wherein said array of light sources on each or said arms contains lights that rotate in common circular pathways as said arms spin.

16. The assembly according to claim 10, wherein said array of light sources contain light emitting diodes.

17. The assembly according to claim 10, wherein different light sources within said plurality of light sources emit different colored light.

18. A method of manufacturing a spinning light assembly, comprising the steps of:
providing a set of arms that radially extend from a central hub, wherein each of said arms is flexible;
attaching an array of lights to each of said arms;
rotating said arms at a predetermined speed;
providing a control circuit in said central hub that rotates with said arms, wherein said control circuit lights said array of lights in at least one predetermined pattern that is synchronized with said predetermined speed to produce at least one selected display of lights as said arms turn.
